(19) United States
(12) Patent Application Publication
(10) Pub. No.: US 2003/0186829 A1
(43) Pub. Date: Oct. 2, 2003

(54) Shaped body comprising a shaped body shell and a shaped body content, especially capsules with one-piece capsule shell, and method for producing shaped bodies and protective coats

(76) Inventor: Hans-J?uuml;rgen Maier, (US)

Correspondence Address: NATH & ASSOCIATES, 1030 15th STREET, 6TH FLOOR, WASHINGTON, DC, 20005, US

(21) Appl. No.: 10/221,041

(22) PCT Filed: Mar. 9, 2001
(86) PCT No.: PCT/EP01/02652

(30) Foreign Application Priority Data
Mar. 10, 2000 (CH) 473/00

(51) Int. Cl. C11D 17/00

(52) U.S. Cl. 510/294; 525/221; 525/222; 510/296; 510/295

(57) ABSTRACT

This invention concerns a molded part containing a molded part shell and a molded part content, where the molded body shell contains at least one film-forming polymer, that has been selected from a group consisting of polyvinyl alcohols and polyvinyl alcohol derivatives. Preferably the polyvinyl alcohol derivative is a polyvinyl acetal described in EP 771 329. The molded part according to the invention can be used as a primary and/or secondary packing agent. The molded part shell features cumulative positive features such as increases maximum elongation values, odor and taste neutrality, good thermoplastic processing capabilities and excellent biological degradation. The processing of the composition is advantageous to capsules with single-piece shells containing a detergent composition as the molded part content.

This invention concerns a molded part containing a shell for the molded part and a molded part content, especially capsules with single-piece capsule shell, as well as processes for the manufacture of molded parts and protective layers according to the generic terms of independent patent claims.

Over the past few years, increased efforts have been made to manufacture packaging materials from at least partially regenerating and biologically degradable material. A large number of publications have referred to starch, starch derivatives, starch mixtures as film-forming basic materials for the manufacture of packaging, molded parts and films, such as EP 118 240, EP 304 401, EP 327 505, EP 397 819, WO 90/14938 and EP 479 964.

In the sense of “one-time packaging”, capsules with appropriate content have been increasingly offered for technical purposes, e.g. capsules with bath additives, detergents, dyes for marking objects, aroma additives or cosmetics, etc.

The capsule shell encloses and “packages” the content in the correct amount measured for the application purpose with the correct composition. This eliminates the need for the end user to measure out the quantity of contents required, which is a time-consuming and error-prone process. The capsule shell must be able to be stored and transported. After the release of the content, the capsule shell material must not cause any negative side effects. It is very important that it can be removed during and after its application without releasing residual substances. These requirements are not fulfilled by the material currently used for capsule shells, i.e. gelatine. Capsule shells made of gelatine do not release their content at temperatures below 40° C. due to their inadequate solubility at these temperatures. Even at higher temperatures, the gel often does not dissolve completely. For example, gelatine capsules filled with detergent concentrate can leave non-dissolved gelatine remains on fibers during laundering at 60° C. This residue causes unacceptable damage during ironing. In addition, gelatine capsules filled with bath additives are not accepted by users if non-dissolved gelatine remains in their bath water. Finally, applications are completely unacceptable in cases where non-dissolved gelatine clogs filters or pipes, thus putting the due and proper use of plants and machinery at risk.

The object of this invention is to eliminate the disadvantages of the prior art.

Especially it is the object of the present invention to provide materials that are appropriate for the manufacture of water-soluble molded parts and films for primary and secondary packaging material.

It is a further object of this invention to provide materials that are appropriate for the manufacturing of molded part shells, especially capsule shells, which are biologically degradable, whose water solubility can be modified for different temperatures, and which in particular can be dissolved in cold water.

These objects are fulfilled through the characteristics of the independent claims.

They are especially solved by a molded part comprising a molded part shell and a molded part content, whereby the molded part shell contains at least one film-forming polymer being selected from a group consisting of polyvinyl alcohol and derivates of polyvinyl alcohol.

Within the context of this invention, the term polyvinyl alcohol should be understood to cover those polyvinyl alcohols which, in addition to the hydroxyl groups resulting from the polyvinyl alcohol structure, also contain other functional groups (such as acetyl) up to a maximum of 0.5 mole percent. If the percentage content of functional groups which are not hydroxyl groups of the polyvinyl alcohol structure exceeds 0.5 mole percent, then the polymers are called derivates of polyvinyl alcohol within the context of this invention. The term derivates of polyvinyl alcohol therefore also includes partially saponified polyvinyl alcohols with a residual content of acetyl groups higher than 0.5 mole percent. The term should, however, only describe such polymers where the percentage content of polyvinyl alcohol is greater than, or equal to, 50 percent of the weight in relation to the total weight of the polymers.

In a preferred embodiment, the molded part shells contain derivates of polyvinyl alcohol the derivates having a residual content of acetyl groups of between 13 to 0.5 mole percent, preferably between 12 and 1 mole percent.

Furthermore, derivates of polyvinyl alcohol which contain at least one acetal group have continued to prove to be especially suitable. The acetal groups may be the only functional groups in a polymer in addition to the hydroxyl groups of the polyvinyl alcohol structure (in the case of the acetalization of polyvinyl alcohol according to the definition). They can also occur in combination with other functional groups (such as acetyl groups). This may be the case, for example, where acetalization reactions are performed on the above described partially saponified polyvinyl alcohols.

In an alternative embodiment, the object is solved by a molded part, comprising a molded part shell and a molded part content, whereby the molded part shell contains at least one film-forming polymer, which contains at least one acetal group per molecule. The polyvinyl alcohols and derivatives of polyvinyl alcohols as mentioned before could be used as polymers. As film-forming polymers, polyalcohols could be used, especially polyalcohols selected from the group of polyglycerols, polypropylene glycols and higher derivatives. They should also form acetals with carbonyls or presumptive carbonyls. The acetal group is introduced into the polyalcohols by means of an acetylation reaction of at least one polyalcohol with at least one natural agent and/or one derivative of natural agent, the natural agent and/or derivate of the natural agent comprising at least one carbonyl group or presumptive carbonyl group. The same natural agents and/or derivatives of natural agent can be used for the reaction with the polyalcohols as they are/have been discussed for polyvinyl alcohols and derivatives of polyvinyl alcohol. In particular, these are natural agents selected from the group consisting of monosaccharides, disaccharides, native and de-polymerized polysaccharides.

In an especially advantageous embodiment, the molded part shell contains the polyvinyl alcohol derivatives described in EP 771 329. The subject and the disclosure content of EP 771 329 taken as a whole are, therefore, part of this invention. The polyvinyl acetals disclosed in EP 771 329 can be manufactured through the acetalization of derivates of polyvinyl alcohol(according to the nomenclature of the present application) comprising at least one natural agent, said natural agent and/or natural agent derivates containing at least one carbonyl group or presumptive carbonyl group and/or natural agent derivatives. The polyvinyl alcohol derivatives used for the synthesis of the polyvinyl acetals have saponification degrees between 80 and 99.5 mole percent, with the preferred degrees lying between 90 and 99 mole percent. The acetalization reaction preferably takes place under an acid catalysis. The term presumptive carbonyl group as used in EP 771 329 covers such natural agents which form functional groups under acetalization conditions, and preferably under acid catalyzed acetalization conditions, which show typical reactions for aldehyde and ketone groups. A typical reaction, for example, is the oxime produced with hydroxylamines. Natural agents and natural agents derivatives containing carbonyl groups are these natural agents which contain reactive aldehyde or ketone groups. Substances could be included as natural agent derivatives which originate from natural agents as a result of physical-mechanical degradation or an enzymatic and/or chemical degradation, such as acid or basic catalysed hydrolysis and/or enzymatic and/or oxidative degradation, and which at the same time maintain respectively form the above mentioned characteristics of carbonyl groups or presumptive carbonyl groups.

Regarding the biological degradation capability of the molded part shells, EP 771 329 polyvinyl acetals are particularly advantageous where the natural agent comprising carbonyl group or the presumptive carbonyl group is selected from the group consisting of monosaccharides, disaccharides, native and de-polymerized polysaccharides. In the case of polysaccharides or, in the case of degraded (de-polymerized) polysaccharides, the oligosaccharides, for example, the reaction takes place with already present terminal or forming terminal hemiacetal groups of polymers or oligomers. De-polymerized starch, especially potato starch and rice starch, have proven to be especially advantageous as de-polymerized polysaccharide. The water-soluble fractions of the acetalization reaction in particular are used.

The medium polymerization degrees of the polyvinyl alcohol derivative prior to acetalization are advantageous in the range from 200 to 2,700, but preferably in the range from 300 to 1,500, and more preferably in the range of 400 from 1,000.

The water solubility of the molded part shell can be varied or modified by varying the degree of acetalization and polymerization, that is by varying the chain length. The water solubility of the molded part according to invention can be regulated by modifying the medium degree of polymerization of the polyvinyl acetals. Here refer to the explanations in EP 771 329.

The molded part shell can also contain one or more substances known for their softening features: water, glycerin, propylene glycol, urea, dimethyl sulfoxide, dimethylformamide,

N-methyl-2-pyrrolidone, polyoxyketone, hexahydric alcohol sorbitol, sorbitan (cyclical linear ether of hexahydric alcohol), oligomeric hydrated starch degradation products (polysorbitol), polyethylene glycol, fatty acid ester of polyethylene glycol, fatty acid ester of glycerin, polyglycerin fatty acid ester, ethoxylated sorbitan fatty acid ester, as well as low molecular polyvinyl alcohols and derivatives. By adding one or more of these compounds, the manufactured molded part shells or films can be modified to meet specific requirement profiles, such as processing at a certain temperature, break resistance, Young's Elasticity Module.

The softeners are contained in amounts between 0.1 weight percent and 70 weight percent in relation to the total weight of the molded part shell.

Surprisingly, it has been shown that polyvinyl acetals which have been acetalized with starch from EP 771 329 contain a high elasticity even with just a small percentage of softeners. Water also works as a softener. A high percentage of water must usually be extracted in a separate processing step after the molding of the molding body to guarantee the stability of the molded part. These polyvinyl acetals allow the presence of a small percentage content of water obviating the need for the additional drying step. A combination of these three components of water, glycerin and hexahydric alcohol has proven to be advantageous. The addition of glycerol monostearate has another positive effect.

In a preferred embodiment, the molded part shell of the molded part contains at least one other polyglycerin with a degree of polymerization of greater than, or equal to, four.

It has been shown that the polyglycerin used as a softener in conjunction with polyvinyl alcohols and derivatives, especially in films or in molded parts from EP 771 329, provides surprisingly high maximum elongation values. The absolute value of the elongation which in addition to the combination of materials is also dependent on the relative amounts of components, is less surprising than the relative increase in the maximal elongation in relation to compositions containing low molecular homologs of the polyglycerin with the same percentage weights (i.e. monoglycerin, diglycerin and triglycerin). When using polyglycerin, for example, an increase of the maximal elongation of more than 60 percent can be achieved in comparison to the same weight of glycerin (according to DIN 51562-1-4). Without adhering to this explanation, it could be originally based on a very advantageous ratio of the number of hydroxyl groups to the average chain length or the average mole weight (weight average). The higher number of hydroxyl groups in comparison to the monomer glycerin is responsible for the increased formation of hydrogen bridges from the softener to the matrix-forming polymer (smaller migration tendency). Simultaneously, the polyglycerin can incorporate itself as a softener in between the matrix forming polymer chains and can guarantee their mutual mobility. The term softener is defined according to DIN 55945 and the Römpp ChemieLexikon, editors J. Falbe, D. Regitz, Georg Thieme, Verlag Stuttgart, 9^{th} edition, pp. 5017-5020. The softening effect can be measured by melting point and the glass temperature depression (DSC).

Polyglycerins are used preferably in purities greater than, or equal to, 70 weight percent, or preferably with a purity of 75 weight percent. This means that the name-giving polyglycerin (e.g. tetraglycerin, hexaglycerin or decaglycerin) is present in weight parts greater than, or equal to, 70 weight percent of the total weight of the polyglycerin. The remaining maximum 30 weight percent is distributed among the lower molecular or higher molecular homologs. The utilized polyglycerins are therefore substances with clearly defined chemical-physical characteristics. This guarantees reproducibility with regard to the specific parameter of the composition. Polyglycerins are physiologically inert, odor and taste neutral, water-soluble, and have excellent softening characteristics for the above described polymers without migrating from the molded part shell.

In an advantageous embodiment, the degree of polymerization of the polyglycerin comprised in the composition according to the invention lies within 5 and 20, and preferably between 6 and 12.

Even more preferable is a polyglycerin with a degree of polymerization of 10, the decaglycerin.

The amount of polyglycerin present in the molded part shell ranges from 0.1 weight percent to 70 weight percent in relation to the total weight of the molded part shell. The preferred weights lie between 10 weight percent and 40 weight percent. Polyglycerin of only one degree of polymerization can be utilized as well as mixtures of polyglycerins with varying degrees of polymerization. The structure of the polyglycerin(s) can be linear, branched or cyclical.

The term molded part, used to differentiate from protective layers which can also be manufactured with the same composition as the molded part, consists of an integral body of any form and thickness which can be manufactured without a formally attached and supporting material, and which can be utilized self-supported.

In the molded part shell of the molded part according to the invention, several relevant and necessary advantages for packing materials are combined. The molded part form shell or the material of the molded part shell can be modified in such a way that they are water soluble or water dispersible in water temperatures below 40° C., and preferably below 35° C. It is almost 100% biologically degradable, odor and taste neutral, and can be adjusted to high elongation values at the processing temperature. These features make them extremely suitable for use as primary or secondary packaging materials. A packaging agent is a molded shell which is normally separate from the packed content, such as bottles, foil, bags, etc. prior to its application or use. Primary packing agents come directly into contact with the package contents, whereas secondary packing agents only come into contact with the primary packaging material. In a preferred embodiment, the primary packing agents are actually part of the product. The shell and contents are part of the application. No opening of the actual content is necessary. Examples from the food industry are soup powder, which is filled into a hose bag and then immersed in water. Examples from the technical field are fertilizers or pesticides which are provided with the shell. The user's safety is significantly increased. A preferred embodiment of such a primary packaging agent is the molded part shell in the design of a capsule comprising capsule content and capsule shell.

In another embodiment, the molded part content of a first molded part according to the invention is a second molded part according to the invention. Preferably the second molded part is a capsule. The shell of the first molded body therefore serves the function of a secondary packing agent for the second molded part, whose shell serves the function of a primary packing agent. The material of the secondary and primary packing agent is selected from a group of same materials. These materials are compositions as already described and are preferably polyvinyl acetals described in EP 771 329 in addition to the advantageous additives already described. In a preferred embodiment, the packed, molded part, that is the first molded part enclosed in a secondary packing agent, is a capsule with a single-piece capsule shell and a liquid detergent composition as capsule content. The first molded part can be applied together with a secondary packing agent. In addition to the aspect of childproof packaging of the first molded part, the time-consuming opening of the molded part is obviated. Additional substances being not suitable for encapsulation can be incorporated in the secondary packaging agent. As the secondary packaging agent is almost 100% biologically degradable, there are no costs involved in the disposal of the secondary packaging agent.

The molded parts can be produced in all conceivable forms based on the high elongation values of the material that forms the molded part shell, especially when formed as a film. The thermoplasticity allows the production of packing forms by other production technologies (such as pouring, dipping, injection molding, co-injection molding, extrusion to flat film, bale film etc.).

As has been mentioned already, a preferred embodiment of the molded part according to the invention is a capsule with a single-piece or two-part capsule shell. The capsule shell can be manufactured using the one or two-part rotary-die-process.

The encapsulation of liquid and pasty content materials presupposes a single-piece capsule shell. Automated continuous manufacturing processes are prevalently used for liquid, and in a broader sense pumpable, capsule contents. The manufacture of capsule shells and their filling takes place in one single step. In this continuous “one-step process”, molded parts are produced, with the capsule shell being closed during and after filling by welding the outer edges of the molded parts. The production of molded parts takes place using molds which come together or move apart, such as in the Norton, Banner and Schering processes, or with rotating roller presses, such as in the rotary die process and in the Accogel process (“The Capsule”, edited by Fahrig/Hofer, Stuttgart, 1983). Filling takes place with the help of dosage pumps that fill a defined amount of the content material during the die-cutting and molding of the molded parts. The welding, that is the formation of the seams, generally takes place by means of pressure and heat. The production costs are significantly lower than when using die casts for two-part cachet shells.

The manufacturing process for single-piece capsules, especially the rotary die process, places several demands on the capsule shell material. One of the main requirements is the capability of the capsule shell material to form highly elastic “endless” tapes of adequate strength. Therefore, the Young Elasticity Module E of the film must not lie above higher than 2 Mpa, and preferably not below 1 Mpa, at the moment of the remolding and filling during the rotary die process. In other words, the film must not offer any resistance to the filling pressure of the filling material, which effectively causes the formation of the capsule shell during the rotary die process, caused through the weight pressure of the filling nozzle, such that the filling material runs between the filling nozzle and the film. Additionally, the hardness am of the capsule shell material must have under the standard conditions (of 25° C. and 60% relative humidity) a value of at least 2 MPa to guarantee sufficient stability of the capsule shell at room temperature (based on storage, transport safety and usage requirements). Furthermore, the capsule shell material should be able to be welded to ensure sufficient stability of the seams. The material of the molded part shell for the molded part according to the invention fulfills these requirements in all aspects. In a preferred embodiment, σₘ is greater than, or equal to, 3.5 MPa, and is preferably greater than, or equal to, 5 MPa. The capsule shell material must also be compatible with a variety of content materials.

In addition, part of this invention is a process for the production of a molded part, and especially for the production of a capsule with a single-piece capsule shell. The process includes the following steps:

a) Providing of a composition containing at least one film-forming polymer selected from a group of polyvinyl alcohols and polyvinyl alcohol derivatives. The composition contains at least one additive in the range from 0.1 to 70 weight percent in relation to the total weight of the composition that has been selected from a group consisting of water, glycerin, propylene glycol, urea, N-methyl-2-pyrrolidone, dimethyl sulfoxide, dimethylformamide, polyoxyketone, hexahydric alcohol, sorbitan, oligomeric hydrated starch degradation products, polyethylene glycol, polyethylene glycol fatty acid ester, glycerin fatty acid ester, polyglycerin fatty acid ester, ethoxylated sorbitan fatty acid ester, as well as polyvinyl alcohols and derivatives thereof and polyglycerin with a degree of polymerization greater than, or equal to, four;

b) Heating of said composition to a flow temperature, preferably in the range between 40° C. and 130° C.;

c) Molding, in particular extrusion of the composition at flow temperature, as a film, the film preferably having thickness of between 0.01 and 2.0 mm;

d) Optionally intermittent storage of the film;

e) Remolding of the film into a molded body, especially into a capsule with a single-piece capsule shell using an intermittent or continuous molding process, in particular using a continuous mold and fill process.

In a preferred embodiment, the used continuous form and filling process in e) for the production of filled capsules with single-piece capsule shell is the rotary die process.

The components of the provided composition as described in a) can be transformed in a preceding step into a preferred homogeneous, storage-stable form, such as granulate. The composition can be processed further after storage. Alternatively, the transformation of the composition into a homogenous state can take place during the heating stage in step b).

In a more preferred embodiment, the film extruded by the extruder is fed directly to the remolding device, that is without intermittent storage of the film in the sense of an in-line production.

One-piece capsules produced using the above mentioned process are exceptionally interesting for technical applications as the water-solubility of the capsule shells can be adjusted in certain temperature ranges. It is possible, for example, to produce capsules which release their content material at water temperatures of between 25° C. and 30° C. This is not possible with the gelatine-based capsules currently available. This feature is especially relevant for the encapsulation of highly concentrated detergent and tenside compounds. It allows the dissolution of the capsule shell, and thus washing, at temperatures below 40° C.

In a preferred embodiment, the molded body according to the invention contains a content of a preferably liquid detergent composition.

The detergent composition ideally contains as tenside N-monoisopropanol ammonium, N,N-diisopropanol ammonium and N,N,N-triisopropanol ammonium salts of fatty alcohols (C₁₂-C₁₄) poly-ethylene glycol (2EO) ether sulfates, or mixtures thereof.

In order to be considered suitable for the encapsulation in water soluble or water dispersible capsule materials, the tensides must fulfill specific requirements regarding the mole weight, the molecule form, the pH value, the water content, viscosity and the chemical reactivity. These requirements must be fulfilled for reasons of compatibility of the capsule material with the capsule shell and with other components in the detergent composition, the storage stability of the capsule, the biological degradation, the dissolution and release conduct in water, the washing activity, the encapsulation technology, and the user application (light weight, space-saving). The above named alkanol ammonium salts of fatty alcohol polyethylene glycol ether sulfate fulfill these criteria almost ideally in combination with the molded body shells of the invention. The detergent composition can contain other common additives, such as enzymes, other tensides, fillers, graying inhibitors, bleaches, etc.

In addition, the water solubility of the capsule shell can be modified in such a way that it only dissolves at high temperatures. This feature makes the capsules interesting for the encapsulation of content material, which can either be pumped or which only exist in liquid state at higher temperatures and which can therefore be enclosed only at higher temperatures. These content materials can also contain a certain percentage of water without damaging the capsule shell.

The same composition mentioned in a) can be processed using die casting into molded bodies and especially into so-called hard capsules, that is into two-part capsules. This process includes providing and mixing of the components of the composition, or providing the already homogeneous composition in a first step, its transformation into a flowable state, which normally requires temperatures of between 40° C. and 130° C., a subsequent die casting of the composition heated to a flow temperature in pre-manufactured die cast mold parts, followed by de-molding from the die casting form parts during or after the cooling of the composition.

The forming of the hard capsules can also take place by dipping them in a molten mass (solution) diluted by water or alcohol.

Alternatively, the composition named under a) can be applied to a body of any shape by means of dipping and spraying in order to create a protective layer. This protective layer could be removed through dissolution, for example with water, before additional processing or application. The composition is dissolved for the dipping or spraying process in a solvent. Preferred solvents are water, low molecular alcohols such as methanol, ethanol, butanol, or mixtures of these solvents. Dipping can also take place out of a molten mass. In this case, the solvent is omitted.

In addition, part of the invention is a composition for the production of form bodies and protective layers containing at least one polyglycerin with a degree of polymerization greater than, or equal to, four, and at least one polymer selected from a group consisting of starch and starch derivatives.

In the sense of the invention, starch includes native starch as well as physically modified starch, but essentially not de-polymerized starch, such as swelling starch. The starches are not limited to a selection of certain plants producing them. The selection of the starches (potato starch, rice starch, corn starch, etc.) depends on their usage.

All starches whose primary polymer structure has been modified (de-polymerized starches, chemical foreign groups carrying modified starched) should be included under the term of starch derivatives within the context of this invention. De-polymerized starches are appropriate for the composition according to the invention.

Preferred starch derivatives are, however, chemically modified starch derivatives. The percentage starch content should be greater than, or equal to, 20 w/w. Preferably, the percentage starch content should be greater than, or equal to 30 w/w, and more preferably it should be 50 w/w in order to be included under the term starch derivative. Starch derivatives that have been modified (acetalized) with polyvinyl alcohols are suitable for the composition according to the invention.

Those starch derivatives which have proven to be especially useful are derivatives with acetalically bonded polyglycerin compounds. During the process, polyglycerin/starch copolymers are formed. In general, the derivatization reagent occurs, independently of the derivatization process, as a reaction with the amylose as well as with the amylopectin molecules. The distribution of foreign groups in the amylose molecules and the amylopectin molecules varies, among other factors (such as the manufacturing method), according to the accessibility of the amylose and amylopectin chains in the starch for the derivatization reagent. These effects are known to experts and will not be explained further.

It might be necessary for certain application purposes to either use only the derivatives of the amylose molecules acetalized with polyglycerin or only the amylopectin acetalized with polyglycerin. This presupposes, however, the separation of amylopectin and amylose molecules, which can take place either prior to or following the derivatization reaction.

The copolymer polyglycerin/starch assumes the purpose of an interior softener (definition of internal softener according to Rompp, 9. Edition). The production of this starch/polyglycerin copolymer can take place analogous to the syntheses described in EP 771 329 or PCT/AT96/00093. The production method is, however, not just limited to this method. The copolymerization of the starch with polyglycerin is preferably performed with polyglycerins which have a degree of polymerization up to, or equal to, 10.

The composition can also contain, in addition to the starch/polyglycerin copolymer, non-bonded polyglycerins. These could be non-reacted polyglycerins from the synthesis which have not been removed after the copolymerization. Alternatively, polyglycerin(s) can be added on demand to the copolymer.

The copolymer starch/polyglycerin can be processed into molded parts of any form based on the internal softening effect even without any additional non-bonded polyglycerin. Part of this invention is, therefore, a composition for the production of molded parts and protective layers containing at least one copolymer of starch and polyglycerin, whereby at least one type of polyglycerin is bound acetalically to the starch.

Polyglycerin can also be bound acetalically to cellulose molecules. In polyglycerin/cellulose copolymers, the internal softening effect described for starch/polyglycerin copolymers takes place in compositions used for the production of molded parts. The cellulose/polyglycerin copolymers can contain non-bonded polyglycerin in one composition, but can be processed into molded parts without the presence of non-bonded polyglycerin. Part of this invention is further a composition for the manufacture of molded parts and protective layers which contains at least one copolymer of cellulose and polyglycerin, whereby at least one type of polyglycerin is bound acetalically to the cellulose. The chain length of the cellulose molecules has been selected in such a way that a derivatization is possible.

In the description of this invention, the technical terms are defined according to Römpp, Chemielexikon [Chemical Lexicon], Editors J. Falbe, M. Regitz, Georg Thieme Verlag, Stuttgart, 9. Edition unless their meaning is explicitly described.

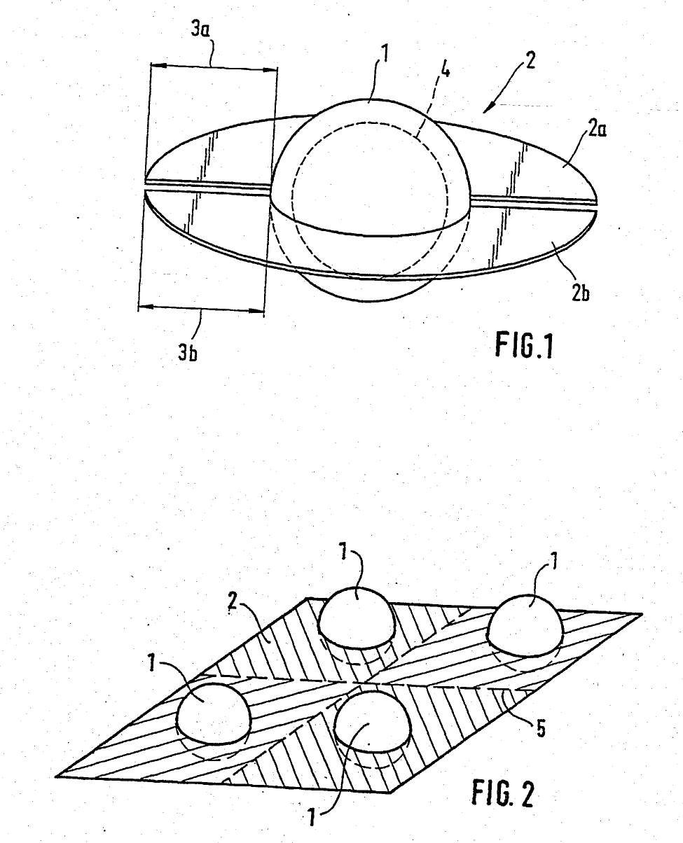

FIG. 1 shows a first molded part according to the invention that is encased by a second molded part according to the invention as a function of a secondary packaging agent (cross section)

FIG. 2 shows several first molded parts according to the invention that are all encased by a second molded part as a function of a secondary packaging agent.

FIG. 1 shows a first molded part 1 according to the invention in the form of a capsule with a single-piece capsule shell 4 and a capsule content (not shown), for example a detergent concentrate. The molded part 1 is enclosed by a second molded structure 2, the secondary package 2, in order to be childproof and to increase storage stability, respectively safety and transport stability. The secondary package 2 can consist of two pieces 2a and 2b, which can be formed through drawing of the foil. The two parts are connected at their contact surface 3a and 3b. Depending on their material composition, they are either glued or welded together. Depending on the material, glue can be applied or the material develops glue features when moistened. The secondary package 2 and the molded part shell 4 of the molded substance 1 according to the invention, the primary package, are manufactured from the same or from similar materials, and contain a film-forming polymer material at least one polyvinyl acetal according to EP 771 329 and at least one additive mentioned in the introduction part of the description. This design has the advantage that the molded part with content, plus the secondary package, is supplied for the final application. A time-consuming opening of the secondary package of the molded part and/or opening of the molded part content from the primary package is thus obviated.

FIG. 2 shows several molded parts 1 that are totally enclosed by a second molded part 2, the secondary package 2. In the shown embodiment, the secondary package has been molded from one piece with breaking ties 5 in order to allow the individual molded parts according to the invention and their secondary packages to be provided for their application purpose.

### EXAMPLES

### Example 1

| | |
|---|---|
| Base compound: | Polyvinyl acetal (according to EP 771329) |
| | granulate type 3-90/9/2T5 (reference Constan- |
| | tia/Vienna) |
| Composition: | 68% base compound |
| | 8% water |
| | 22% glycerin |
| | 1% glycerin monostearate |
| | 1% lecithin |
| Strip manufacture: | Chill roll extrusion |
| | Strip thickness 600 μm |
| Capsule manufacture: | Rotary die process |
| Fill material: | Paraffin oil |
| Charge: | 0.5 g/capsule |
| Form: | Oval |
| Drying: | Not applicable |
| Test: | Capsule shell completely soluble in water at |
| | 19° C. |

### Example 2

| | |
|---|---|
| Base compound: | Polyvinyl acetal (according to EP771329) |
| | granulate type 3.5/11/1 (reference Constan- |
| | tia/Vienna) |
| Composition: | 68% base compound |
| | 8% water |
| | 22% glycerin |
| | 1% glycerin monostearate |
| | 1% lecithin |
| Strip manufacture: | Chill roll extrusion |
| | Strip thickness 600 μm |
| Capsule manufacture: | Rotary die process |
| Fill material: | Paraffin oil |
| Charge: | 0.5 g/capsule |
| Form: | Oval |
| Drying: | Not applicable |
| Test: | Capsule shell completely soluble in water at |
| | 19° C. |

### Example 3

| | |
|---|---|
| Base compound: | Polyvinyl acetal (according to EP771329) |
| | granulate type 3-40/9 (Reference Constan- |
| | tia/Vienna) |
| Composition: | 65% base compound |
| | 4% water |
| | 10% glycerin |
| | 20% sorbitol |
| | 1% glycerin monostearate |
| Strip manufacture: | Chill roll extrusion |
| | Strip thickness 600 μm |
| Capsule manufacture: | Rotary die process |
| Fill material: | Paraffin oil |
| Charge: | 1 g/capsule |
| Form: | Round |
| Drying: | Not applicable |
| Test: | Capsule shell completely soluble in water at |
| | 19° C. |

In a comparison test, an acetalized polyvinyl alcohol according to EP 771 329 (type 3-90/9/2T5/Constantia Vienna) of the composition: 41 weight percent starch; 11% glycerin and 8.4% water was mixed once with glycerin (Example 4) and once with the same weight of decaglycerin (Example 5).

| Example 4 | Example 5 |
|---|---|
| 63 g Extrudate | 63 g Extrudate |
| 14 g Glycerin | 14 g Decaglycerin |

Both components were transformed in a Brabend kneader at 130° C. into a homogeneous composition and pressed to a film of 600 μm. alternatively, it can be melted in an extruder (fine combed, twin screw extruder turning in the same direction at 80-130° C.; 50-300 rpm) and then extruded to film through a wide slot nozzle onto cooled rolls <40° C. The film's elongation was measured according to DIN 51 562-1 −4 at 21° C. and 21% relative humidity an average value from four individual measurements.

| | |
|---|---|
| Example 1 | Example 2 |

Max. measured elongation [in %]:

| | |
|---|---|
| 141.99 | 214.79 |

Elongation [MPa]:

| | |
|---|---|
| 4.65 | 3.27 |

Young's Elasticity Module (Mpa)

| | |
|---|---|
| 40.34 | 12.54 |

1. Molded part containing a molded part shell and a molded part content, characterized in that the molded part shell contains at least one film-forming polymer that has been selected from a group consisting of polyvinyl alcohols and polyvinyl alcohol derivatives.

2. Molded part according to claim 1, characterized in that the polyvinyl alcohol derivatives has a residual content of acetyl groups between 13 and 0.5 mole percent, preferably between 12 and 1 mole percent.

3. Molded part according to claim 1 or 2, characterized in that the polyvinyl alcohol derivatives has at least one acetal group per molecule.

4. Molded part according to claim 3, characterized in that the acetal group is introduced through an acetalization reaction of at least one polyvinyl alcohol derivative with at least one natural agent and/or natural agent derivative, said natural agent and/or natural agent derivative containing at least one carbonyl group or presumptive carbonyl group.

5. Molded part according to one of the claims 1 to 4, characterized in that the average degree of polymerization of the polyvinyl alcohols and/or of the polyvinyl alcohol ranges between 200 and 2700, preferably between 300 and 1500, and more preferably between 400 and 1000.

6. Molded part comprising a molded part shell and a molded part content, characterized in that the molded part shell contains at least one film-forming polymer, said polymer containing at least one acetal group per molecule.

7. Molded part according to claim 6, characterized in that the acetal group is introduced through an acetalization reaction of at least one polyalcohol with at least one natural agent and/or natural agent derivatives, said natural agent and/or natural agent derivative containing at least one carbonyl group or presumptive carbonyl group.

8. Molded part according to claim 7, characterized in that the polyalcohol has been selected from the group of polyglycerides, polypropylene glycol and higher derivatives.

9. Molded part according to claim 4 or 7, characterized in that the natural agent is selected from a group consisting of monosaccharides, disaccharides, native and de-polymerized polysaccharides.

10. Molded part according to claim 9, characterized in that the de-polymerized polysaccharide is de-polymerized starch, preferably potato starch.

11. Molded part according to one of the claims 1 to 10, characterized in that the molded part shell contains at least one more substance ranging from 0.1 to 70 weight percent in relation to the total weight of the molded part shell, which is selected from a group consisting of water, glycerin, propylene glycol, urea, dimethyl sulfoxide, dimethylformamide, N-methyl-2-pyrrolidone, polyoxyketone, hexahydric alcohol, sorbitan, oligomeric hydrated starch degradation products, polyethylene glycol, polyethylene glycol fatty acid ester, glycerin fatty acid ester, polyglycerin fatty acid ester, ethoxylated sorbitan fatty acid ester, as well as polyvinyl alcohols and derivatives thereof.

12. Molded part according to one of the claims 1 to 11, characterized in that the molded part shell contains at least one polyglycerin with a degree of polymerization of greater than, or equal to, four.

13. Molded part according to claim 12, characterized in that the polyglycerin is decaglycerin.

14. Molded part according to one of the claims 12 or 13, characterized in that the polyglycerin is present in an amount of between 0.1 weight percent and 70 weight percent, preferably between 10 weight percent and 40 weight percent in relation to the total weight of the molded part shell.

15. Molded part according to one of the claims 1 to 14, characterized in that the content has a solid, paste-like, liquid or gaseous consistency.

16. Molded part according to claim 15, characterized in that the molded part content is preferably a liquid detergent composition.

17. Molded part according to claim 16, characterized in that the detergent composition contains tensides which are selected from the group consisting of N-monoisopropanol ammonium, N,N-Diisopropanol ammonium and N,N,N-Triisopropanol ammonium salts of the fatty alcohol (C₁₂-C₁₄) polyethylene glycol (2EO)ether sulfates.

18. Molded part according to one of the claims 1 to 17, characterized in that the molded part is a capsule with a one or two-part shell.

19. Molded part according to claim 16, characterized in that the capsule can be manufactured by the rotary die process.

20. Production process of a molded part, preferably capsules with single-piece capsule shells comprising the following steps:
a) Providing a composition containing at least one polymer selected from a group of polyvinyl alcohols and polyvinyl alcohol derivatives, whereby the composition contains at least one additive between 0.1 and 70 weight percent in relation to the total weight of the composition that has been selected from a group consisting of water, glycerin, propylene glycol, urea, N-methyl-2-pyrrolidone, dimethyl sulfoxide, dimethylformamide, polyoxyketone, hexahydric alcohol, sorbitan, oligomeric hydrated starch degradation products, polyethylene glycol, polyethylene glycol fatty acid ester, glycerin fatty acid ester, polyglycerin fatty acid ester, ethoxylated sorbitan fatty acid ester, as well as polyvinyl alcohols and derivatives thereof and polyglycerin with a degree of polymerization greater than, or equal to, four;
b) Heating of this composition to a flow temperature, preferably at between 40° C. and 130° C.;
c) Molding, especially extruding of the composition at flow temperature as film;
d) Optionally intermittent storage of the film;
e) Remolding of the film into a molded body, preferably into a capsule with a single-piece capsule shell, using an intermittent or continuous molding process, in particular using a continuous mold and fill process.

21. Molded part according to claim 20, characterized in that the continuous molding process is the rotary die process.

22. Process for the production of a molded part, preferably of a two-part capsule shell with the following steps:
a) Providing a composition containing at least one polymer selected from a group of polyvinyl alcohols and polyvinyl alcohol derivatives, whereby the composition contains at least one additive between 0.1 and 70 weight percent in relation to the total weight of the composition that has been selected from a group consisting of water, glycerin, propylene glycol, urea, N-methyl-2-pyrrolidone, dimethyl sulfoxide, dimethylformamide, polyoxyketones, hexahydric alcohol, sorbitan, oligomeric hydrated starch degradation products, polyethylene glycol, polyethylene glycol fatty acid ester, glycerin fatty acid ester, polyglycerin fatty acid ester, ethoxylated sorbitan fatty acid ester, as well as polyvinyl alcohols and derivatives thereof and polyglycerin with a degree of polymerization greater than, or equal to, four;
b) Heating of this composition to a flow temperature, preferably at between 40° C. and 150° C.;
c) Die casting of the composition brought to flow temperature in a pre-produced die casting mold;
d) De-molding of the die-cast molded parts in c) from the die-casting form during or after cooling.

23. Process for the production of a protective layer characterized by the following steps:
a) Providing a composition containing at least one polymer selected from a group of polyvinyl alcohols and polyvinyl alcohol derivatives, whereby the composition contains at least one additive in the range of 0.1 to 70 weight percentages regarding the total weight of the composition that has been selected from a group consisting of water, glycerin, propylene glycol, urea, N-methyl-2-pyrrolidone, dimethyl sulfoxide, dimethyl-formamide, polyoxyketones, hexahydric alcohol, sorbitan, oligomeryc, hydrated starch degradation products, polyethylene glycol, polyethylene glycol fatty acid ester, glycerin fatty acid ester, polyglycerin fatty acid ester, ethoxylated sorbitan fatty acid ester, as well as polyvinyl alcohols and derivatives thereof and polyglycerin with a degree of polymerization greater than, or equal to, four;
b) Dissolving of the composition in an appropriate solvent or solvent mixture;
c) Dipping or spraying the solution on a body of any form;
d) Drying of the solution by extracting the solvent.

24. Molded form according to one of the claims 1 to 16, where the molded part content is a second molded part according to one of the claims 1-16.
